(19) United States
(12) Patent Application Publication
(10) Pub. No.: US 2025/0123377 A1
(43) Pub. Date: Apr. 17, 2025

(54) DEVICE AND METHOD FOR TESTING A LIDAR SENSOR

(71) Applicant: dSPACE GmbH, Paderborn (DE)

(72) Inventors: Andreas HIMMLER, Paderborn (DE); Stefan SCHUKAT, Paderborn (DE); Rainer WOLSFELD, Borchen (DE); Jan LACHMAIR, Bielefeld (DE); Christian PILGER, Bielefeld (DE)

(73) Assignee: dSPACE GmbH, Paderborn (DE)

(21) Appl. No.: 18/916,625

(22) Filed: Oct. 15, 2024

(30) Foreign Application Priority Data
Oct. 13, 2023 (DE) 10 2023 128 062.7

(51) Int. Cl. G01S 7/497; G01S 7/481

(52) U.S. Cl. CPC G01S 7/497; G01S 7/4812

(57) ABSTRACT

A device for testing a lidar sensor. The lidar sensor being configured to emit first light having a first wavelength. The device comprising a trigger detector that is configured to receive the first light on a first optical path. The trigger detector being configured to generate a trigger signal as a function of the received first light. At least one transmitting device is configured to emit second light having a second wavelength, as a function of the trigger signal. The second light being receivable on a second optical path by the lidar sensor. An optical element is configured to separate the first optical path from the second optical path.

This nonprovisional application claims priority under 35 U.S.C. § 119(a) to German Patent Application No. 10 2023 128 062.7, which was filed in Germany on Oct. 13, 2023, and which is herein incorporated by reference.

### BACKGROUND OF THE INVENTION

### Field of the Invention

The present application relates to a device and a method for testing a lidar sensor, and to a test stand, in particular a roller test stand, for testing the lidar sensor.

### Description of the Background Art

A device and a method for isolating a trigger signal for a test system of a lidar sensor are described in DE 102021106220 A1, which corresponds to US 2022/0291355, which is incorporated herein by reference. An optical element is provided which is arranged in front of a converging lens or a trigger detector and situated in a signal path of the trigger signal. The optical element is designed to allow the trigger signal to pass through, and to at least partially absorb a back reflection of the trigger signal that passes through the optical element and that is reflected in particular at a surface. The polarization of the light is utilized for this purpose. The optical element may be designed as an optical isolator, in particular as a Faraday isolator, wherein the Faraday rotator in this case is situated between a first polarizer and a second polarizer.

### SUMMARY OF THE INVENTION

It is therefore an object of the invention to provide a lidar sensor that is configured to emit first light having a first wavelength. A device for testing the lidar sensor comprises: a trigger detector that is configured to receive the first light on a first optical path, the trigger detector being configured to generate a trigger signal as a function of the received first light, at least one transmitting device that is configured to emit second light, having a second wavelength, as a function of the trigger signal, the second light being receivable on a second optical path by the lidar sensor, an optical element that is configured to separate the first optical path from the second optical path.

A method for testing a lidar sensor comprises: emitting first light, having a first wavelength, by the lidar sensor, receiving the first light on a first optical path by a trigger detector, generating a trigger signal by the trigger detector as a function of the received first light, emitting second light, having a second wavelength, by at least one transmitting device as a function of the trigger signal, and receiving the second light on a second optical path by the lidar sensor, wherein an optical element separates the first optical path from the second optical path.

The device or the method for testing the lidar sensor enables the separation between the first light having the first wavelength, which the lidar sensor emits, and the second light having the second wavelength, which the lidar sensor is to receive. The separation may be carried out in a cost-effective and spatially compact manner. In general, it is noted that the term “light” is to be broadly interpreted, and has been selected for better readability. Electromagnetic waves are intended, which may also be present in nonvisible wavelength ranges.

The described device and the described method for testing the lidar sensor allow the lidar sensor to be confronted, and thus tested, with various situations that may occur in reality. The situations are simulated for the lidar sensor by means of the second light. This type of testing may also be referred to as over-the-air (OTA) testing. It is thus possible to also check, for example, specified test cases that are prescribed by a contracting or regulatory authority, for example. The described device may be advantageously used in particular in a roller test stand in order to test a lidar sensor that is installed in a vehicle situated on the roller test stand.

With regard to assisted or autonomous driving, correct functioning of such a lidar sensor is imperative. The described device and the described method may be advantageously used to spare test drives and also to test, in a short period of time, a number of various traffic situations that may occur. The device and the method allow testing of the lidar sensor via an optical transmit/receive interface (over-the-air). This allows the lidar sensor to be tested, regardless of its installation and/or whether it is already installed, for example in a vehicle.

The lidar sensor emits the first light by means of a light source, for example laser light via one or more laser diodes. The lidar sensor then evaluates received second light. If the lidar sensor is in the operating mode for surroundings detection, the second light generally involves back reflections from the surroundings of the lidar sensor. However, the evaluation of the second light, for example via the so-called time-of-flight principle or also via a Doppler shift, also allows determination of distances as well as movements of objects in the visual field of the lidar sensor. Movement of the objects may in particular mean the direction, or also the speed or acceleration or other motion parameters. A lidar sensor is often used in conjunction with other sensors, for example a radar sensor and/or a camera sensor, to obtain the necessary redundancy and reliability of such information concerning the visible objects.

The lidar sensor can be configured to emit first light having a first wavelength. The present disclosure describes how the wavelength may be used for the separation of the optical paths.

The trigger detector, which can be configured to receive the first light on a first optical path and to generate the trigger signal as a function of the received first light, has a receiver for the first light. The receiver of the trigger detector may convert the received first light into an electrical signal, for example, using an optical-electrical converter. For this purpose, the receiver may include photodiodes, other light-sensitive diodes, or electronic components, or also other optical-electrical converters such as a photomultiplier or an interferometer.

The at least one transmitting device can be configured to emit second light, having a second wavelength, as a function of the trigger signal, the second light being receivable on a second optical path by the lidar sensor. For example, the transmitting device includes laser diodes or conventional light-emitting diodes which emit the second light at the second wavelength. This emission is triggered by the trigger signal, which is an electrical signal, for example. The first wavelength and the second wavelength are in particular different, and may be used for the separation of the optical paths. The second light is received by the lidar sensor via the second optical path, the lidar sensor therefore likewise having an optical-electrical converter, for example photodiodes, PIN diodes, etc.

The at least one transmitting device may also have, for example, a transmit matrix, for example a field of pixels that can emit the second light. The transmitting device may also have multiple transmit matrices. Optionally, the optical properties of the light of the individual pixels may be improved via microlenses in the case of fields of microlens arrays (MLAs), for example by better concentration or collimation. It is then possible, for example, to also individually control, for example, individual pixels of the transmit matrix or the transmit matrices of the at least one transmitting device. For example, an individual laser diode in a field of laser diodes, i.e., a laser diode array of the transmit matrix, may be controlled and activated in this way. By use of the at least one transmitting device, this enables a high level of flexibility with regard to the simulated reflection signals of the simulated objects, also synthetic objects, that the lidar sensor sees in its visual range.

The device is designed in such a way that the lidar sensor perceives the received second light as back reflection of its emitted first light. The received second light is evaluated by the lidar sensor and used for surroundings detection. By use of the second light that is transmitted by the transmitting device, it is thus possible for the lidar sensor to simulate the surroundings containing objects.

The separation of the first and second optical paths is advantageous, since the situation may be avoided that first light emitted by the lidar sensor is reflected at the at least one transmitting device, and this reflection is received by the lidar sensor. Due to this received reflection, the lidar sensor could perceive the at least one transmitting device, i.e., the test apparatus, as an object in its surroundings. This may be avoided by use of the described device and the described method.

The optical element is provided for separation of the two optical paths. The separation is achieved in particular as a function of the first and second wavelengths. The optical path is the path followed by the first or second light when passing through the air as optical medium and when passing through the optical element. A characteristic of the separation of the first and second optical paths is, for example, that at least one of the optical paths undergoes at least one geometric change, for example a change in direction. The change in direction may also be only an angular change, for example.

The geometric change can be brought about by the optical element, either directly or indirectly. “Directly” means that the optical path or the optical paths run(s) through the optical element and undergo the geometric change. “Indirectly” means that the optical path or the optical paths undergo(es) the geometric change in direction outside the optical element. The indirect change may take place in particular due to the interaction with further elements.

The optical element may be situated in both optical paths, i.e., in the first optical path and in the second optical path. The separation of the two optical paths is thus easily achievable, since both paths contain the optical element.

Furthermore, it is possible for the optical element to be configured to separate the first optical path, at least on the side facing away from the lidar sensor, from the second optical path. The optical separation by the optical element takes place with an effect on the side of the optical element facing away from the lidar sensor. That is, in particular the first light and the second light extend in parallel between the optical element and the lidar sensor, and do not extend in parallel on the side facing away from the lidar sensor or on the sides of the optical element facing away from the lidar sensor. Therefore, the first optical path and the second optical path on the side facing the lidar sensor extend essentially in parallel. The side of the optical element facing the lidar sensor refers to the area between the optical element and the lidar sensor on the shortest path. It is possible for multiple sides to face away from the lidar sensor, depending on the shape of the optical element. In that case, the sides facing away from the lidar sensor are those sides which do not face the lidar sensor. These sides are all included in the stated facing-away side.

The side facing away from the lidar sensor may thus refer to the area between the optical element and the trigger detector and/or between the optical element and the at least one transmitting device. The portion of the first optical path between the optical element and the trigger detector is thus situated on the side facing away from the lidar sensor. The portion of the second optical path between the transmitting device and the optical element is thus situated on the side facing away from the lidar sensor.

Furthermore, it is possible for the at least one transmitting device and the trigger detector to be situated spatially separate from one another. This allows a particularly compact design of the device. Alternatively, it is possible to situate the trigger detector and the transmitting device on the same component. In addition to the separation of the first and second paths by the first optical element, further beam deflections may then be provided.

In addition, it is advantageous that the first wavelength is not equal to the second wavelength, and the separation of the first optical path and of the second optical path takes place as a function of the wavelength. This may be implemented, for example, by carrying out the separation by the optical element based on the wavelength. The optical element may, for example, be designed as a dichroic mirror or may include a dichroic mirror. Dichroic mirrors are designed to combine or separate two or more light beams having different wavelengths. They may be designed as long-pass mirrors, for example, in which the long wavelengths are transmitted and the short wavelengths are reflected. In one design as a short-pass mirror, the short wavelengths are passed through and the long wavelengths are reflected. Dichroic mirrors may have an alternating layered structure. In the coating, metallic layers may alternate with dielectric layers. Alternatively, low-refractive and high-refractive dielectric layers may be used in alternation. Dichroic mirrors are also referred to as interference filters. Dichroic mirrors are able to reflect the light of a wavelength with very low loss, and are therefore suitable, for example, for lasers such as in lidar. For a dichroic mirror, the rate of reflection may be set very precisely and in practically any desired manner as a function of the wavelength by suitably selecting the number of layers, layer thickness, and/or refractive index of the dielectrics used, which is helpful for the desired wavelength-dependent separation of light, in particular from laser beams.

The dichroic mirror can be designed to reflect the first light having the first wavelength on the first optical path, and to transmit the second light having the second wavelength on the second optical path. This means that the path of the first light is deflected and thus undergoes a geometric change. The second light may continue on its path. It is also possible that the first light having the first wavelength is transmitted, and the second light having the second wavelength is reflected.

The use of various wavelengths makes it easily possible to efficiently separate the two optical paths by using the dichroic mirror, for example. It is possible for the first wavelength to be approximately 905 nm or approximately 1550 nm. The same applies for the second wavelength. The first and second wavelengths may be selected in such a way that both are in the range of approximately 905 nm or both are in the range of approximately 1550 nm. The first wavelength may be specified by the lidar sensor, namely, as the wavelength at which the lidar sensor operates. The second wavelength may be selected in such a way that separation of the optical paths by the dichroic mirror is made possible, but the lidar sensor perceives received second light having the second wavelength as a reflection of its emitted first light, for example due to the small difference from the first wavelength. In this way, the surroundings for the lidar sensor may be simulated and the lidar sensor may be tested.

At least one optical deflection unit can be provided in the second optical path, via which the second light emitted by the at least one transmitting device is deflectable to the optical element or to the lidar sensor. If the deflection unit is situated on the side of the second path facing away from the lidar sensor, it guides the second light toward the optical element. If the deflection unit is situated on the side of the second path facing the lidar sensor, it guides the second light toward the lidar sensor. That is, the second optical path undergoes a change in direction as a result of this deflection unit. The optical deflection unit thus allows further optimization of the spatial configuration. The optical deflection unit may be designed as a mirror, or the optical deflection unit may include such a mirror.

At least one optical deflection unit may additionally or alternatively be provided in the first optical path, via which the first light emitted by the lidar sensor is deflectable to the optical element or to the trigger detector. If the deflection unit is situated on the side of the first path facing away from the lidar sensor, it guides the first light away from the trigger detector. If the deflection unit is situated on the side of the first path facing the lidar sensor, it guides the first light away from the optical element. The optical deflection unit thus allows further optimization of the spatial configuration. The optical deflection unit may be designed as a mirror, or the optical deflection unit may include such a mirror.

Furthermore, the first and/or the second optical path can include at least one further optical element. These may be further mirrors or a damper or some other optical element, such as a filter. It is also possible for both paths to be initially deflected, for example by means of a mirror, and then separated.

The described device for testing the lidar sensor may include a test stand, in particular a roller test stand, for a vehicle having a lidar sensor. It is thus possible to cost-effectively test the lidar sensor in the installed state. In particular, a particularly compact design of the test stand is made possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of the device according to the invention,

FIG. 2 shows a schematic illustration of an example of the device according to the invention,

FIG. 3 shows a schematic illustration of a test stand, and

FIG. 4 shows a flow chart of the method.

### DETAILED DESCRIPTION

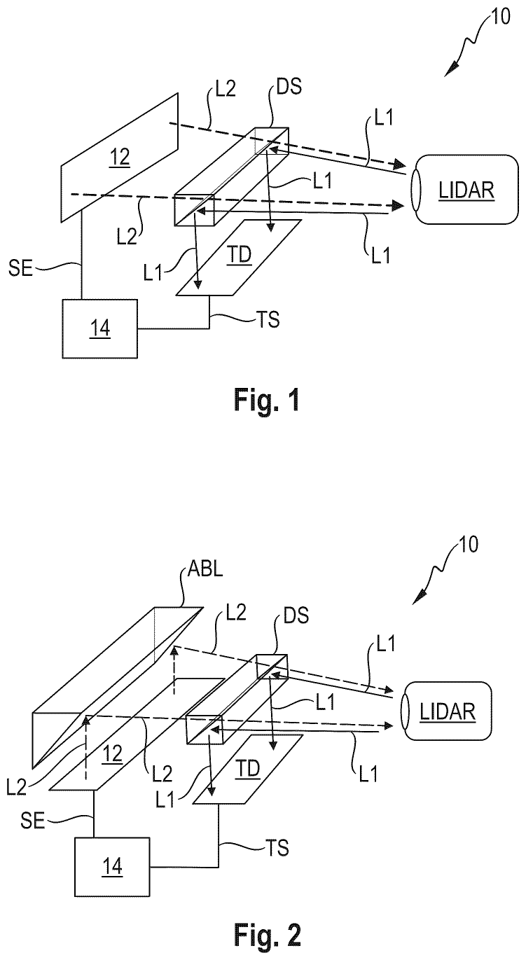

FIG. 1 shows a device 10, and a lidar sensor LIDAR that emits first light L1. The device 10 tests the lidar sensor LIDAR via the air, i.e., wirelessly and in particular via the optical interface of the lidar sensor. The lidar sensor LIDAR may, for example, already be installed in a vehicle 20.

The lidar sensor LIDAR sends first light L1 having a first wavelength into the device 10. The first light L1 strikes the first optical element DS. The first light L1 is deflected by an optical element DS onto a trigger detector TD. The optical element DS is designed as a dichroic mirror that is configured to reflect light having the first wavelength. In the illustrated example, the first light L1 is deflected, by the reflection at the dichroic mirror, to the trigger detector TD.

The trigger detector TD receives the first light L1 and converts it into an electrical signal by means of an optical-electrical converter which includes a photodiode or PIN diode, for example. The electrical signal is processed in the trigger detector TD, and generates a trigger signal TS as a function of the electrical signal. The processing may involve signal conditioning in which the trigger signal TS is generated from the first light L1. Signal processing may take place which includes smoothing and/or amplification and also more. The processing in the trigger detector TD may also include, for example, pattern recognition and/or analysis of the first light L1 converted into an electrical signal, using one or more threshold values.

For the processing, the trigger detector TD may have signal processing circuit components, for example a processor, wherein the signal processor generates the trigger signal TS from the received light L1.

The trigger signal TS is transferred to an object simulator 14 via an electrical line, for example. It is also possible for the transfer of the trigger signal TS to be achieved via an optical signal or a radio signal, for example. The object simulator 14 may then include corresponding converters for converting the trigger signal TS into an electrical signal, which the object simulator 14 may process electrically.

The processing in the object simulator 14 may include, for example, recognizing that the lidar sensor LIDAR has emitted the first light L1, and the solid angle at which the emission took place. Based on this solid angle, the lidar sensor LIDAR would then also anticipate the return signal. The object simulator 14 can now simulate the surroundings for the lidar sensor LIDAR by simulating objects in the surroundings of the lidar sensor LIDAR and transferring a corresponding control signal SE to the transmitting device 12. The simulated objects may then be simulated by the transmitting device 12 for the lidar sensor LIDAR via emitted second light L2.

As a function of the trigger signal TS, the object simulator 14 thus generates the control signal SE, which the object simulator 14 electrically transfers to the transmitting device 12. Here as well, other forms of transfer such as by optics or via radio would be possible. In the present case a hard-wired transfer is used.

The transmitting device 12 sends second light L2 as a function of the control signal SE. The second light L2 is emitted at a second wavelength. The second wavelength differs from the first wavelength such that the second light L2 is guided by the optical element DS, which is designed as a dichroic mirror. The optical element DS is designed in such a way that it allows light of the second wavelength to pass through. The second light L2 thus passes through the dichroic mirror, and then strikes the lidar sensor LIDAR on a side of the lidar sensor LIDAR facing the optical element DS. The second light L2 is received by the lidar sensor LIDAR, converted into an electrical signal, and further processed. The second wavelength is selected in such a way that it is far enough away from the first wavelength to enable the separation by the optical element DS. The second wavelength is likewise selected in such a way that it is close enough to the first wavelength to be perceived by the lidar sensor LIDAR as a reflection of the emitted first light L1. The simulation of objects is then enabled, and the lidar sensor LIDAR may be tested.

The processing of the control signal SE by the transmitting device 12 may also include pattern recognition, for example, wherein further factors may have an additional effect on the emitted second light L2. These factors include the objects that are to be simulated by the transmitting devices 12. These objects are generated by the object simulator 14, for example, and are communicated to the transmitting device 12 via the control signal SE.

The object simulator 14 is used to simulate the objects that the lidar sensor LIDAR is intended to be able to see in its visual range, for example to test the lidar sensor LIDAR. The objects are simulated in such a way that via the transmitting devices 12, artificial reflection signals are emitted by second light L2 that is generated in the transmitting devices 12. Various objects, object locations, object sizes, and/or object characteristics may be simulated using the second light L2. The transmitting device 12 may have one or more laser arrays or LED arrays for this purpose. The laser arrays or LED arrays may have the same or different designs, and may each have individual laser sources or LED sources. The laser arrays or LED arrays and/or the individual laser sources or LED sources may also be mechanically displaceable, for example. A particular transmitting device 12 may include the individual laser sources or LED sources and/or laser arrays or LED arrays as light sources. Other light sources are also conceivable. Due to the displaceability, movement of simulated objects may be simulated, and tracking of objects by the lidar sensor LIDAR may thus also be tested in a dynamic setting. The mechanical displacement may take place in one or more directions. The lidar sensor LIDAR may thus be tested for whether the lidar sensor LIDAR can receive, distinguish, and identify all of these test objects that are simulated by the transmitting devices 12. This later makes it possible to correctly guide a vehicle 20 as a function of its surroundings, which have been detected by the lidar sensor LIDAR, or by providing a driver with information about what actions to take.

FIG. 2 shows a schematic illustration of an example of the device 10. The device 10 is connected to a lidar sensor LIDAR via the air. The lidar sensor LIDAR emits first light L1 having a first wavelength, which is deflected onto the trigger detector TD by the optical element DS. The optical element DS is designed as a dichroic mirror which is configured in such a way that it reflects light having the first wavelength. In the illustrated example, the first light L1 is deflected to the trigger detector TD by the reflection at the dichroic mirror.

The trigger detector TD converts the received first light L1 into a trigger signal TS that is transferred to the object simulator 14. As a function of this trigger signal TS, the object simulator 14 generates the control signal SE, which the object simulator 14 transfers to the transmitting device 12. The control signal SE is also a function of the objects to be simulated for the lidar sensor LIDAR.

The transmitting device 12 generates the second light L2, having the second wavelength, as a function of the control signal SE. The second light L2 may optionally be emitted by various light sources of the transmitting device 12. The second light L2 is deflected onto the lidar sensor LIDAR via the deflection unit ABL, with the second light L2 passing through the optical element DS. The optical element DS designed as a dichroic mirror is configured in such a way that it allows light having the second wavelength to pass through, i.e., is transparent to light having the second wavelength.

By use of the deflection unit ABL it is possible to lengthen the second optical path for the second light L2, which may be important for a realistic test of the lidar sensor LIDAR. It may be advantageous, for example, to increase the spacing of the optical elements of the transmitting device 12 by means of longer beam paths. Such a length of the second optical path may be achieved by the deflection unit ABL, while at the same time the necessary space for the device may be kept small. Optionally, the deflection unit ABL, for example its orientation in space, may be controlled by the object simulator 14. However, it is possible for the deflection unit ABL to be static and always positioned the same, so that the light L2 is a function only of how it is emitted by the transmitting device 12 and how it thus strikes the deflection unit ABL. In addition to the illustrated components, it is also possible for further optical elements such as lenses, other mirrors, and optical diodes to be situated in the optical paths.

The design illustrated in FIG. 2 thus allows an even more compact arrangement.

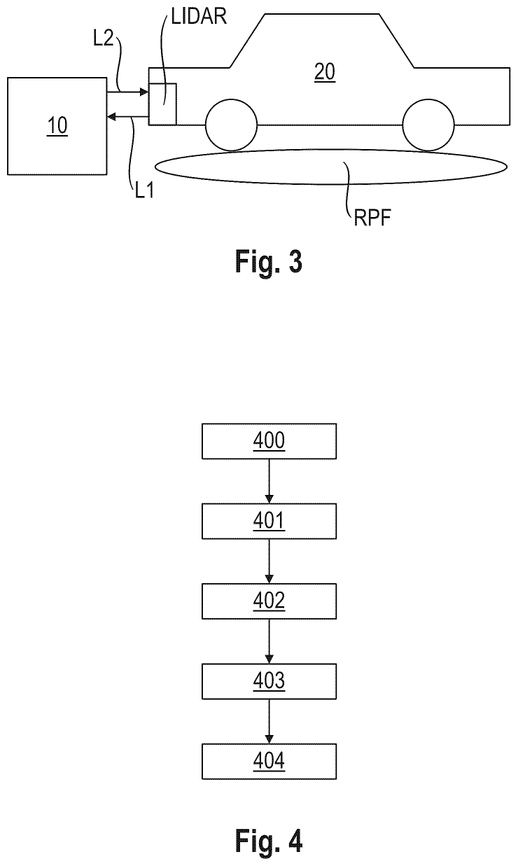

FIG. 3 shows a test stand together with the device 10. A vehicle 20 includes the lidar sensor LIDAR, which emits the first light L1 into the device 10. The lidar sensor LIDAR receives the second light L2 from the device 10. The vehicle 20 rests on a roller test stand RPF, via which the vehicle 20 may be moved at a certain speed and acceleration. In this way scenarios, for example for autonomous driving, may be tested which can verify the functional capability of the lidar sensor LIDAR. In the present case, the lidar sensor LIDAR is in its actual installed position in the vehicle 20, for example in or at the headlights, in or at the bumper, or other locations at the front end of the vehicle. Some other arrangement, for example at the upper edge of the windshield, is also possible. The lidar sensor LIDAR and/or further lidar sensors may be situated in other areas of the vehicle 20. The device 10 may then be situated appropriately in the visual field of the lidar sensor for testing.

FIG. 4 shows a flow chart of an example of the method for testing the lidar sensor LIDAR.

The lidar sensor LIDAR outputs the first light L1 having the first wavelength on a first optical path in method step 400.

The trigger detector TD receives the first light L1 on the first optical path in method step 401. After step 400 and before step 401, the first light L1 received by the trigger detector TD on the first optical path has passed through the optical element DS.

The trigger detector TD generates the trigger signal TS in method step 402 as a function of the received first light L1.

In method step 403 the object simulator 14 generates the control signal SE as a function of the trigger signal TS, and transfers the control signal SE to the transmitting device 12, which emits the second light L2 having the second wavelength on the second optical path as a function of the control signal SE. The generation of the control signal SE as a function of the trigger signal TS is carried out by the object simulator 14, as described with reference to FIG. 1 or 2, for example.

The second light L2 is received on the second optical path by the lidar sensor LIDAR in method step 404. After step 403 and before step 404, the second light L2 received on the second optical path by the lidar sensor LIDAR has passed through the optical element DS.

The lidar sensor LIDAR can then generate a reception signal. As a function of this reception signal, the lidar sensor LIDAR can generate a test signal or some other output signal, for example, on the basis of which the success of the testing of the lidar sensor LIDAR may be assessed.

The optical element DS is situated, for example, in the first optical path and the second optical path. The optical element DS separates the first optical path and the second optical path in such a way that the first optical path and the second optical path run crosswise relative to one another after the separation. This separation takes place using the particular wavelengths of the first light and the second light, for example using a dichroic mirror or some other optical element that operates based on wavelengths.

The first optical path of step 400 and the second optical path of step 404 may thus extend in parallel or essentially in parallel to one another, so that a realistic reception situation may be simulated for the lidar sensor LIDAR. The first optical path of step 401 and the second optical path of step 403 may thus run crosswise relative to one another, so that the trigger detector TD and the transmitting device 12 can be situated apart from one another.

Due to the described arrangement, it is possible to position the transmitting device 12 in such a way that the transmitting device itself is not perceived by the lidar sensor LIDAR as an object in the surroundings. The transmitting device may be positioned outside the visual field of the lidar sensor LIDAR and still emit the second light L2 for the reception by the lidar sensor LIDAR.

In an example, after step 403, for example, the second light L2 may be guided onto the optical element DS via the deflection unit ABL, and subsequently received by the lidar sensor LIDAR in step 404.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for testing a lidar sensor, the lidar sensor being configured to emit a first light having a first wavelength, the device comprising:
a trigger detector that is configured to receive the first light on a first optical path, the trigger detector being configured to generate a trigger signal as a function of the received first light;
at least one transmitting device that is configured to emit a second light having a second wavelength as a function of the trigger signal, the second light being receivable on a second optical path by the lidar sensor; and
an optical element that is configured to separate the first optical path from the second optical path.

2. The device according to claim 1, wherein the optical element is arranged in the first optical path and in the second optical path.

3. The device according to claim 1, wherein the optical element is configured to separate the first optical path, at least on a side facing away from the lidar sensor, from the second optical path.

4. The device according to claim 1, wherein the first optical path and the second optical path on a side facing the lidar sensor extend essentially in parallel.

5. The device according to claim 1, wherein the at least one transmitting device and the trigger detector are arranged spatially separate from one another.

6. The device according to claim 1, wherein the first wavelength is not equal to the second wavelength, and wherein the separation of the first optical path and of the second optical path is a function of the wavelength.

7. The device according to claim 6, wherein the optical element is a dichroic mirror.

8. The device according to claim 7, wherein the dichroic mirror reflects the first light having the first wavelength on the first optical path, and to transmit the second light having the second wavelength on the second optical path.

9. The device according to claim 1, wherein the first wavelength is approximately 905 nm or approximately 1550 nm.

10. The device according to claim 1, wherein at least one optical deflection unit is provided in the second optical path, via which the second light emitted by the at least one transmitting device is deflectable to the optical element or to the lidar sensor.

11. The device according to claim 1, wherein at least one optical deflection unit is provided in the first optical path, via which the first light emitted by the lidar sensor is deflectable to the optical element or to the trigger detector.

12. The device according to claim 11, wherein the optical deflection unit includes at least one mirror.

13. The device according to claim 1, wherein the first and/or the second optical path include(s) at least one further optical element.

14. A test stand, in particular a roller test stand, for a vehicle, the test stand comprising:
a lidar sensor; and
the device according to claim 1.

15. A method for testing a lidar sensor, the method comprising:
emitting first light having a first wavelength, by the lidar sensor;
receiving the first light on a first optical path by a trigger detector;
generating a trigger signal by the trigger detector as a function of the received first light;
emitting second light having a second wavelength, by at least one transmitting device as a function of the trigger signal; and
receiving the second light on a second optical path by the lidar sensor, wherein an optical element separates the first optical path from the second optical path.

16. The method according to claim 15, wherein the optical element separates the first optical path from the second optical path on a side of the optical element facing away from the lidar sensor.

17. The method according to claim 15, wherein the optical element is a dichroic mirror.
